(19) United States
(12) Patent Application Publication
(10) Pub. No.: US 2016/0040461 A1
(43) Pub. Date: Feb. 11, 2016

(54) Magnetic Lock

(71) Applicant: Trick Technologies Oy, Expoo (FI)

(72) Inventor: Timo Pekka Kauppila, Espoo (FI)

(73) Assignee: TRICK TECHNOLOGIES OY, Espoo (FI)

(21) Appl. No.: 14/819,977

(22) Filed: Aug. 6, 2015

Related U.S. Application Data
(60) Provisional application No. 62/034,371, filed on Aug. 7, 2014.

(51) Int. Cl. E05C 19/16

(52) U.S. Cl. CPC E05C 19/163; E05C 19/161

(57) ABSTRACT

A magnetic lock is presented. The magnetic lock includes a base having a cylindrical opening disposed therein, and having a first magnetic element disposed in a bottom surface of the cylindrical opening of the base. The lock further includes an insert removably securable within the cylindrical opening of the base, the insert having a second magnetic element disposed along a bottom surface thereof. When the insert is inserted into the cylindrical opening of the base and the first magnetic element of the base is aligned with the second magnetic element of the insert the insert is locked within the cylindrical opening of the base. When the insert is rotated within the cylindrical opening of the base to a position wherein the first magnetic element and the second magnetic element are not aligned with each other the insert is removable from the cylindrical opening of the base.

### CROSS REFERENCE TO RELATED APPLICATIONS

The present application claims the benefit of U.S. Provisional Patent Application No. 62/034,371, filed on Aug. 7, 2014, which is incorporated herein by reference in its entirety.

### BACKGROUND

Magnets have a number of applications in industrial and commercial goods. One such application is as a method of joining, locking, or aligning two components together. This is achieved by utilizing the attributes of magnetic fields produced by magnets. These magnetic fields cause magnets with opposing polarities facing each other to attract each other, while the same polarities facing each other repel. Such magnetic fields, regardless of polarity, also attract metallic objects. By utilizing the attractive nature of magnets, locking mechanisms can be built, either by using two magnets, or a magnet and a ferromagnetic material.

One example of such an application would be the magnetic lock on a power cord to a laptop computer, or the small magnets used to close and lock in place the cover for a notebook or tablet computer. In such an application small permanent magnets are used, usually small neodymium magnets, which while exerting a strong magnetic field in comparison to their small size, can be pulled away from each other with relative ease in a perpendicular motion by the user, and hence do not require any external tools or large strain to open.

For applications where a stronger lock or magnetic attractive force is required, usually an electromagnet is used. This is because permanent magnets would be too difficult to pull away from each other using human mechanical strength alone. Electromagnets in this case are much more practical, since a simple power button can release the locking mechanism by deactivating the magnetic field and hence attractive forces.

### SUMMARY

Conventional magnetic locks for electronic devices, such as those explained above, suffer from a number of deficiencies. One such deficiency is that conventional magnetic locks using small permanent magnets do not provide a strong lock or magnetic force due to their small size. A deficiency with conventional electromagnetic locks is that they require a power source and are usually heavier and more complicated to implement than permanent magnets and hence can be more expensive and impractical.

Embodiments of the invention significantly overcome such deficiencies by providing a locking mechanism using strong permanent magnets, often composed of rare earth metals, which can still be unlocked or detached using the conventional strength of a user. This magnetic lock can be used in applications where a low weight is desired, or where there is no available power source to power an electromagnet.

In one particular embodiment the locking mechanism is composed of two parts. A first part includes an internal cylindrical cavity with a first magnetic element (a permanent magnet or a piece of material that is attractable to a magnet) attached to the bottom. The second part includes a matching cylinder that fits into the cylindrical cavity with a second magnetic element attached to its bottom. At least one of the magnetic elements comprises a magnet. The magnetic elements are positioned in such a way that they have a strong attractive force when the cylinder is in one type of orientation within the cavity. This attraction is caused by the full alignment of the magnetic elements with each other. When a twisting motion is applied to the cylinder, the magnetic elements become misaligned. While still being in contact with each other, the lower surface area causes a much smaller attractive force, allowing the user to pull the two magnetic elements apart by pulling the cylinder from the cavity.

Note that each of the different features, techniques, configurations, etc. discussed in this disclosure can be executed independently or in combination. Accordingly, the present invention can be embodied and viewed in many different ways. Also, note that this summary section herein does not specify every embodiment and/or incrementally novel aspect of the present disclosure or claimed invention. Instead, this summary only provides a preliminary discussion of different embodiments and corresponding points of novelty over conventional techniques. For additional details, elements, and/or possible perspectives (permutations) of the invention, the reader is directed to the Detailed Description section and corresponding figures of the present disclosure as further discussed below.

### BRIEF DESCRIPTION OF THE DRAWINGS

The foregoing will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1A depicts an isometric view of a magnetic lock in accordance with a particular embodiment of the present invention.

FIG. 1B depicts an isometric view of a magnetic lock in a locked position in accordance with a particular embodiment of the present invention.

FIG. 1C depicts an isometric view of a magnetic lock in an unlocked position in accordance with a particular embodiment of the present invention.

FIG. 2A depicts an isometric view of a pair of magnetics proximate each other in accordance with a particular embodiment of the present invention.

FIG. 2B depicts an isometric view of a pair of magnetics in a locked position in accordance with a particular embodiment of the present invention.

FIG. 2C depicts an isometric view of a pair of magnetics in an unlocked position in accordance with a particular embodiment of the present invention.

FIG. 2D depicts an isometric view of a pair of magnetics showing the attractive forces in accordance with a particular embodiment of the present invention.

FIG. 2E depicts an isometric view of a pair of magnetics showing the attractive forces in accordance with a particular embodiment of the present invention.

FIG. 2F depicts an isometric view of a pair of magnetics showing the attractive forces and repulsive forces in accordance with a particular embodiment of the present invention.

FIG. 3A depicts an isometric view of a pair of magnetics proximate each other in accordance with a particular embodiment of the present invention.

FIG. 3B depicts an isometric view of a pair of magnetics in a locked position in accordance with a particular embodiment of the present invention.

FIG. 3C depicts an isometric view of a pair of magnetics in an unlocked position in accordance with a particular embodiment of the present invention.

FIG. 3D depicts an isometric view of a pair of magnetics showing the attractive forces in accordance with a particular embodiment of the present invention.

FIG. 3E depicts an isometric view of a pair of magnetics showing the attractive forces in accordance with a particular embodiment of the present invention.

FIG. 3F depicts an isometric view of a pair of magnetics showing the attractive forces and repulsive forces in accordance with a particular embodiment of the present invention.

FIG. 4A shows an embodiment using multiple magnets in accordance with a particular embodiment of the present invention.

FIG. 4B shows an embodiment using multiple magnets in accordance with a particular embodiment of the present invention.

FIG. 5 shows a particular embodiment of the magnetic lock for an electronic device.

### DETAILED DESCRIPTION

The embodiments set forth below represent the necessary information to enable those skilled in the art to practice the invention and illustrate the best mode of practicing embodiments of the invention. Upon reading the following description in light of the accompanying figures, those skilled in the art will understand the concepts of the invention and recognize applications of these concepts not particularly addressed herein. It should be understood that these concepts and applications fall within the scope of the disclosure and the accompanying claims.

The preferred embodiment of the invention will now be described with reference to the accompanying drawings. The invention may, however, be embodied in many different forms and should not be construed as limited to the embodiment set forth herein; rather, this embodiment is provided so that this disclosure will be thorough and complete, and will fully convey the scope of the invention to those skilled in the art. The terminology used in the detailed description of the particular embodiment illustrated in the accompanying drawings is not intended to be limiting of the invention. In the drawings, like numbers refer to like elements.

In building such a magnetic lock, there are aspects that one needs to take into account. One aspect is the dimensions of the bar magnets. The bar magnets should be rectangular in shape and have a width to length ratio that is preferably between 2:1 and 5:1. Smaller ratios, such as that of squares 1:1, would not create the desired effect of lowering the magnetic forces upon a rotational movement along the center axis. Higher ratios, in turn, would still create the desired effect, however, since rare earth magnets are brittle, such “thin” magnets would be easier to break during assembly and transport

A second aspect for consideration is the orientation of the magnetic fields. When two bar magnets are used, the two magnets can have one of two field orientations. In one case, both bar magnets can have their north and south poles located on the flat surface of the magnet. In these cases, the magnets are placed in the cylinder in such a manner that the bottom magnet attached to the cylindrical cavity has the same magnetic orientation as the magnet placed at the bottom of the cylinder. This, in turn, ensures that the magnets attract each other. In such an orientation, there are two possible situations where the two magnets are fully aligned, both 180 degree rotation of the cylinder away from each other. Another version has the magnetic poles situated at the ends of each bar magnet. In this case, there is only one possible full alignment between the two bar magnets. This is useful if the position of the cylinder is desired to face a certain position when locked (magnets are aligned).

A third aspect to be considered is the placement of the magnetic elements within the cylinder. The two magnetic elements have to be located on the central axis of the cylinder, with the center of the magnetic elements aligned with this central axis. Without alignment, the magnetic forces would not align properly causing a weaker locking mechanism. This would also not allow for the misalignment property to function as intended.

Still another aspect for consideration is the fact that the magnetic elements cannot come into direct contact with each other if composed of rare earth metals. This arrangement requires a protective layer to be placed on top of the bottom, top or both magnetic elements to avoid the magnetic elements being damaged when the locking motion is being carried out. Such a protective layer can be achieved by a polycarbonate sticker, overcoming the brittle nature of rare earth magnets.

The magnetic elements can also be broken down into two or more magnetic elements to create the same desired magnetic field and hence the same locking outcome. Such an application is advantageous when the middle part of the axis is required for another component or when using individual smaller magnetic elements can save weight or reduce cost. For example, instead of having a bar magnet with one side with south polarity, one could have several coin magnets or other shaped magnets next to each other with a southern polarity facing up, representing a similar magnetic field.

The present invention is described below referencing a cylindrical insert, though it should be appreciated that any shaped insert (square, rectangular, octagonal, etc.) could be used. The lock uses an insert, which is required to direct the motion of the locking mechanism. Without it, the magnets will just misalign but there is no controlled direction for the release of the lock. The insert also provides more rotational torque to the user making it easier to misalign the magnets, even very strong permanent magnets. The cylindrical cavity along with the insert guides the users pulling motion. Further, the description describes the magnetic elements as being permanent magnets, though it should be appreciated that at least one of the magnetic elements must be a magnet, while the other magnetic element can be a magnet or can be a piece of material that is magnetically attractable.

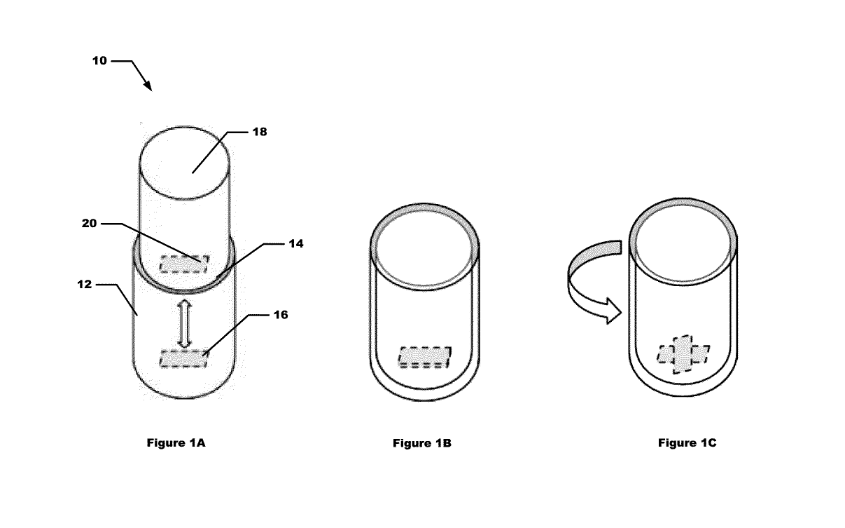

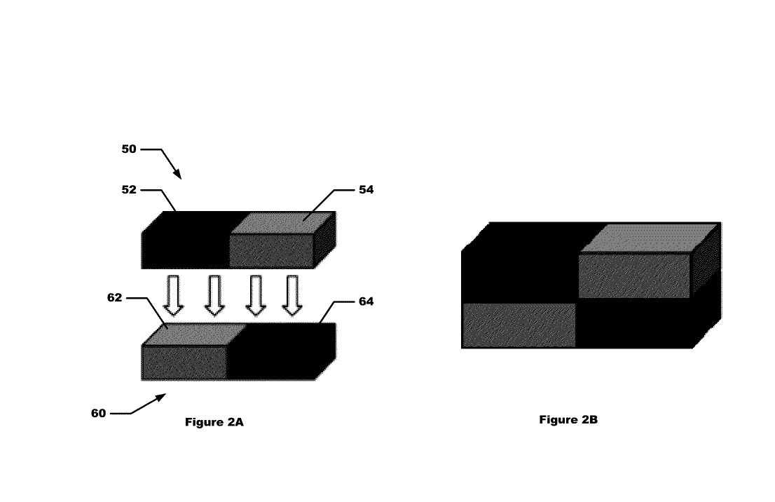

Referring now to FIGS. 1A-1C, an example of a device 10 incorporating a magnetic lock is shown. Device 10 includes a base 12 having a cylindrical opening 14 within which insert 18 can fit. The cylindrical opening 14 in base 12 has a first magnetic elementl6 disposed along a bottom surface of the opening. Insert 18 includes a second magnetic element along a bottom surface thereof. One or both of the magnetic elements is a permanent magnet.

When the insert 18 is inserted into the cylindrical opening 14 of the base 12 and the first magnetic element 16 of the base is aligned with the second magnetic element 20 of the insert 18 the insert 18 is locked within the cylindrical opening 14 of the base 12 and wherein when the insert 18 is rotated within the cylindrical opening 14 of the base to a position wherein the first magnetic element 16 and the second magnetic element 20 are not aligned with each other the insert 18 is removable from the cylindrical opening 14 of the base 12.

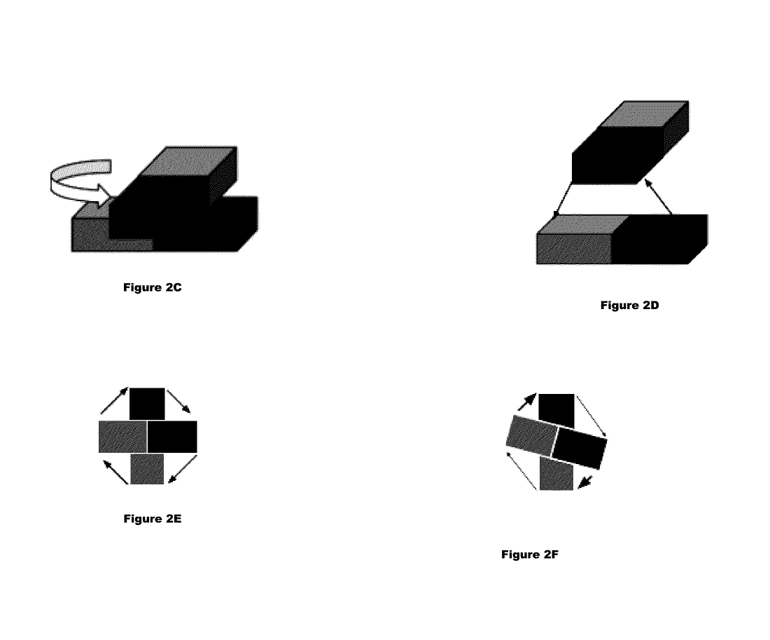

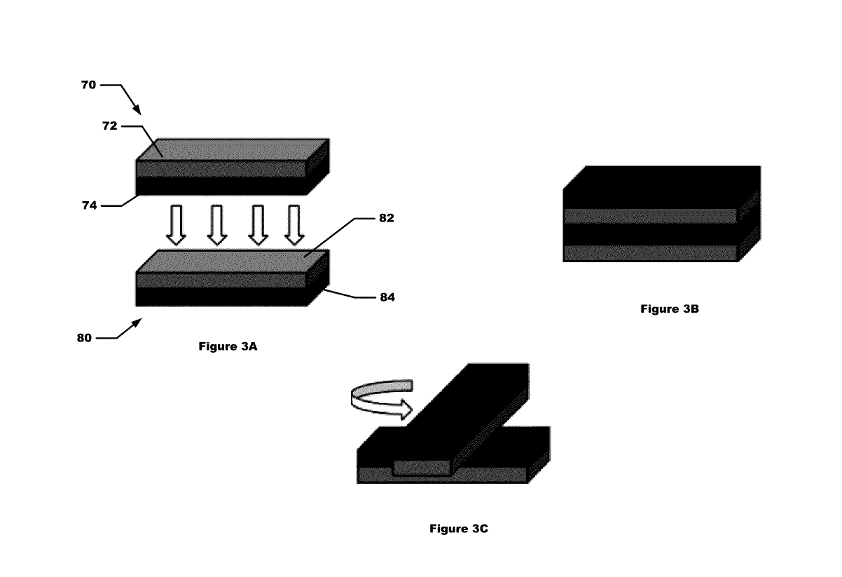

Referring now to FIGS. 2A-2F, in a particular embodiment using two magnets as the magnetic elements, as opposed to having one magnet and a piece of material magnetically attractable as the two magnetic elements, the poles 52 and 54 of the magnet 50 are at the tips of the bar magnet. The poles 62 and 64 of the magnet 60 are at the tips of the bar magnet. Having the poles on the tips of the bar magnets provides the added benefit that when you twist such an arrangement, the similar poles of the two magnets start facing each other. This, in turn, causes the attractive forces between the two magnets to diminish while the repelling forces begin to increase, as more of the surface area and magnetic field of the north pole is being in contact with the north pole/magnetic field of the opposing magnet. The resulting orientation pushes the magnets apart, helping the user unlock the system by only twisting. Hence, while a 90 degree rotational movement will misalign the magnetic fields and hence allow the user to pull the magnets apart, a 180 degree twisting motion will not only cause the magnetic fields to misalign, unlocking the locking mechanism, but it will also cause the magnets to push each other apart, making the locking mechanism more successful since the user needs pull less.

Another benefit is that when the user puts the insert in the cavity, there is a lower chance that the magnets will not lock with each other, attributed by a misalignment of the magnets. This is because, unlike the other arrangement (magnetic poles on the faces of the magnets), when the two magnets are 90 degrees separated, the north pole of one magnet will push the north pole of the other magnet while the south pole pulls. These forces combine to cause a twisting force for the bar magnet as seen in FIG. 2F. Another added benefit of such an arrangement is that a misalignment can cause noticeable upward pressure due to the repelling forces of the two misaligned magnets, indicating to the user that the magnets did not align and hence did not lock. This is an important haptic indicator for the user because it is impossible for the user to see inside the cylindrical cavity after placing the insert into the cylindrical opening. Hence, without any feedback from the locking mechanism the only way to make sure that the magnets have been correctly aligned is by trying to pull on the magnetic lock and see if it will be released manually.

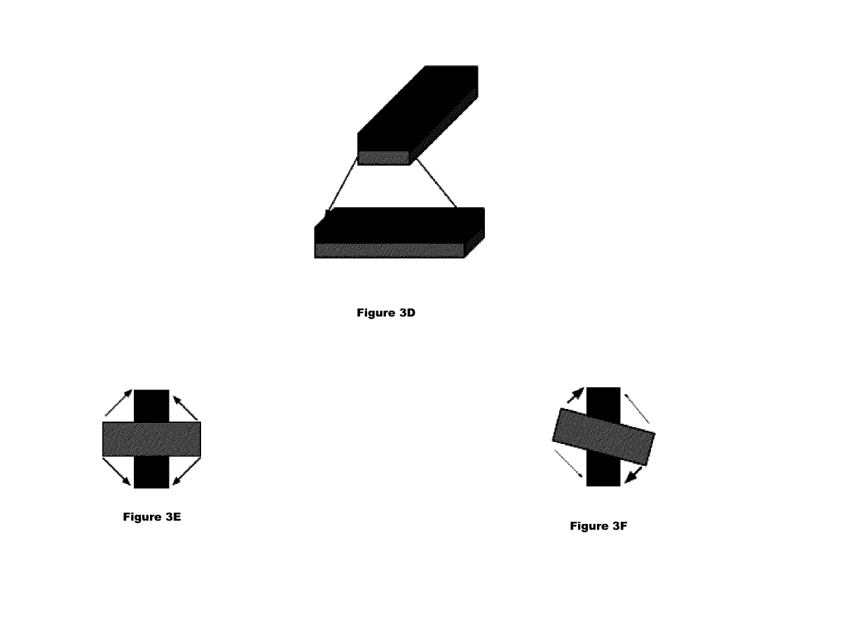

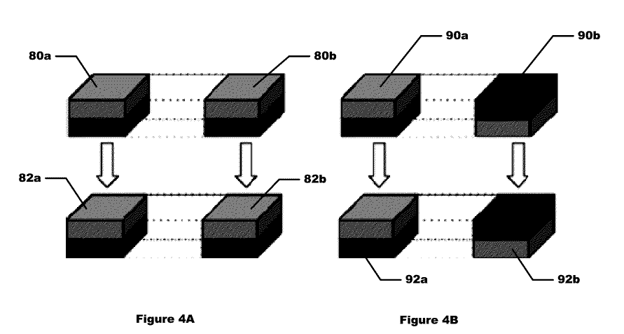

Referring now to FIGS. 3A-3F, in this particular embodiment the poles 72 and 74 of the magnet 70 are at the faces of the bar magnet. The poles 82 and 84 of the magnet 80 are at the faces of the bar magnet. When poles are at the faces, the ends of the bottom bar magnet will both try to attract the tip of the other bar magnet, trying to get the magnet to twist. These forces will cancel each other out in a 90 degree set up. Once the two magnets 70 and 80 are slightly aligned towards one arrangement, the magnets should theoretically immediately align, since now one attraction force will be greater due to the shorter distance, however, when using the cylinder arrangement, there are usually frictional forces caused by the sides of the cylinder as well as the contact between the magnets that also needs to be overcome, meaning, even though the angle between the two bar magnets in the arrangement would be more than 90 degrees, for example 60 degrees, the magnetic forces pulling/twisting the magnets to align with each other, might not overcome the frictional forces, leaving the magnets to be not entirely aligned, and hence, the locking mechanism would not be as effective due to the minimal magnetic forces at work.

Referring now to FIGS. 4A-4B, multiple magnets may be used with both the insert and the base. In FIG. 4A, magnets 80A and 80B are disposed having the same polarity. Magnets 82A and 82B are also disposed having the same polarity, further magnet 80A and 82A will be attracted to each other, as will magnets 80B and 82B. In FIG. 4B, magnets 90A and 90B are disposed having the opposite polarity. Magnets 92A and 92B are also disposed having the opposite polarity, further magnet 90A and 92A will be attracted to each other, as will magnets 90B and 92B.

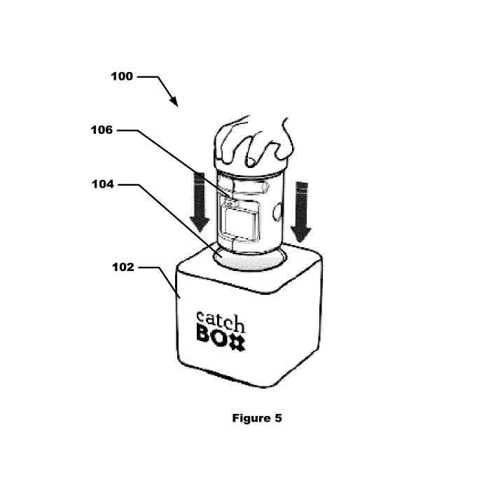

Referring now to FIG. 5, in a particular embodiment the magnetic lock described above is used in a device such as a throwable microphone 100. The base 102 is a soft, padded structure. The microphone portion 106 fits within the base opening 104. Magnets (not shown) in the base and the microphone portion 106 are used to lock the microphone portion 106 within the base 102. As such, the device 100 can be handled (including being thrown) with the microphone portion 106 magnetically locked with the base 102. If the microphone portion 106 needs to be removed from the base 102, the microphone portion 106 is rotated and easily removed.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems.

Throughout the entirety of the present disclosure, use of the articles “a” or “an” to modify a noun may be understood to be used for convenience and to include one, or more than one of the modified noun, unless otherwise specifically stated.

Elements, components, modules, and/or parts thereof that are described and/or otherwise portrayed through the figures to communicate with, be associated with, and/or be based on, something else, may be understood to so communicate, be associated with, and or be based on in a direct and/or indirect manner, unless otherwise stipulated herein.

Although the methods and systems have been described relative to a specific embodiment thereof, they are not so limited. Obviously many modifications and variations may become apparent in light of the above teachings. Many additional changes in the details, materials, and arrangement of parts, herein described and illustrated, may be made by those skilled in the art.

Having described preferred embodiments of the invention it will now become apparent to those of ordinary skill in the art that other embodiments incorporating these concepts may be used. Accordingly, it is submitted that the invention should not be limited to the described embodiments but rather should be limited only by the spirit and scope of the appended claims.

What is claimed is:

1. A magnetic lock base comprising:
a base having a cylindrical opening disposed therein, and having a first magnetic element disposed in a bottom surface of said cylindrical opening of said base;
wherein when an insert is inserted into said cylindrical opening of said base and said first magnetic element of said base is aligned with a second magnetic element of said insert, said insert is locked within said cylindrical opening of said base and wherein when said insert is rotated within said cylindrical opening of said base to a position wherein said first magnetic element and said second magnetic element are not aligned with each other, said insert is removable from said cylindrical opening of said base; and
wherein at least one of said first magnetic element and said second magnetic element comprises a permanent magnet.

2. The magnetic lock base of claim 1 wherein at least one of said first magnetic element and said second magnetic element comprises a material attractable to a magnet.

3. The magnetic lock base of claim 1 wherein said first magnetic element has an orientation selected from the group consisting of an orientation wherein:
north and south poles of said first magnetic element are located on a flat surface of the first magnetic element; and
north and south poles of said first magnetic element are located at the ends of said first magnetic element.

4. The magnetic lock base of claim 1 wherein a central axis of said first magnetic element is in alignment with a central axis of said cylindrical opening of said base.

5. The magnetic lock base of claim 1 further comprising a cover disposed over said first magnetic element.

6. The magnetic lock base of claim 1 further comprising at least one additional magnetic element disposed in said bottom surface of said cylindrical opening of said base.

7. A magnetic lock insert comprising:
an insert capable of being removably securable within a cylindrical opening of a base, said base including a first magnetic element disposed in a bottom surface of said cylindrical opening of said base, said insert having a second magnetic element disposed along a bottom surface thereof; and
wherein when said insert is inserted into said cylindrical opening of said base and said first magnetic element of said base is aligned with a second magnetic element of said insert, said insert is locked within said cylindrical opening of said base and wherein when said insert is rotated within said cylindrical opening of said base to a position wherein said first magnetic element and said second magnetic element are not aligned with each other, said insert is removable from said cylindrical opening of said base; and
wherein at least one of said first magnetic element and said second magnetic element comprises a permanent magnet.

8. The magnetic lock insert of claim 7 wherein at least one of said first magnetic element and said second magnetic element comprises a material attractable to a magnet.

9. The magnetic lock insert of claim 7 wherein said second magnetic element has an orientation selected from the group consisting of an orientation wherein:
north and south poles of said second magnetic element are located on a flat surface of the second magnetic element; and
north and south poles of said second magnetic element are located at the ends of said second magnetic element.

10. The magnetic lock insert of claim 7 wherein a central axis of said second magnetic element is in alignment with a central axis of said cylindrical opening of said base.

11. The magnetic lock insert of claim 7 further comprising a cover disposed over said second magnetic element.

12. The magnetic lock insert of claim 7 further comprising at least one additional magnetic element disposed in said bottom surface of said magnetic lock insert.

13. The magnetic lock insert of claim 7 further comprising a microphone disposed therein.

14. A magnetic lock comprising:
a base having a cylindrical opening disposed therein, and having a first magnetic element disposed in a bottom surface of said cylindrical opening of said base;
an insert removably securable within said cylindrical opening of said base, said insert having a second magnetic element disposed along a bottom surface thereof; and
wherein when said insert is inserted into said cylindrical opening of said base and said first magnetic element of said base is aligned with said second magnetic element of said insert said insert is locked within said cylindrical opening of said base and wherein when said insert is rotated within said cylindrical opening of said base to a position wherein said first magnetic element and said second magnetic element are not aligned with each other said insert is removable from said cylindrical opening of said base.

15. The magnetic lock insert of claim 14 wherein at least one of said first magnetic element and said second magnetic element comprises a material attractable to a magnet.

16. The magnetic lock of claim 14 wherein said first magnetic element and said second magnetic element have an orientation selected from the group consisting of an orientation wherein:
north and south poles of at least one of said first and second magnetic elements are located on a flat surface of the magnetic elements; and
north and south poles of at least one of said first and second magnetic element are located at the ends of said magnets.

17. The magnetic lock of claim 14 wherein a central axis of said first magnetic element and a central axis of said second magnetic element are in alignment with a central axis of said cylindrical opening of said base.

18. The magnetic lock of claim 14 further comprising a cover disposed over at least one of said first magnetic element and said second magnetic element.

19. The magnetic lock of claim 14 further comprising at least one the group consisting of:
at least one additional magnetic element disposed in said bottom surface of said magnetic lock insert; and
at least one additional magnetic element disposed along a bottom surface of said cylindrical opening of said base.

20. The magnetic lock of claim 14 further comprising a microphone disposed within said insert.
